(19) United States
(12) Patent Application Publication
(10) Pub. No.: US 2014/0099172 A1
(43) Pub. Date: Apr. 10, 2014

(54) Suction-Cup Cargo Netting System

(71) Applicant: Eli Geske, Weston, FL (US)

(72) Inventor: Eli Geske, Weston, FL (US)

(21) Appl. No.: 13/646,837

(22) Filed: Oct. 8, 2012

(51) Int. Cl. B60P 7/06; B65D 65/22

(52) U.S. Cl. 410/118

(57) ABSTRACT

A suction-cup cargo netting device that can be secured to any type of vehicle, land-based or marine, such that items can be secured by the device while they are being transported. The suction-cup cargo netting device uses a flexible net that has a plurality of flexible suction-cups on its periphery that secure to any smooth surface quickly and conveniently. After use, the suction-cups and cargo net can be easily removed for storage, or use with another vehicle or another location such as a residence or commercial building. The suction-cups are attached to the periphery of a central net that covers the items being transported such that they are secured to a surface and create a storage area between the cargo net and the surface.

### CROSS-REFERENCE TO RELATED APPLICATIONS

This non-provisional patent application is related to, and claims the benefit of, currently pending Provisional Patent Application Ser. No. 61/550,483, titled “Suction-Cup Cargo Netting System,” filed Oct. 24, 2011, and naming Eli Geske, the named inventor herein, as sole inventor, and is hereby incorporated herein in its entirety.

### BACKGROUND

1. Technical Field

This invention relates in general to vehicle and marine accessories, and more particularly it relates to a quick disconnect netting system for retaining miscellaneous items within a land or marine vehicle.

2. Background of the Invention

Vehicles of any kind are used to transport a wide variety of objects. These can be smaller personal objects transported in the family car, larger objects transported in a vehicle such as an SUV or an open pickup truck, as well as items transported in marine vehicles such as boats, or even personal marine vehicles such as kayaks or the commercially available Sea-Doo ™ watercraft. A problem associated with most vehicles is the inconvenience associated with transporting a variety of loose items that the owner wants to keep safely in place while the vehicle is in motion.

In the case of a land vehicle, storage space may be at a premium. As a consequence, some owners would like to have a convenient way of temporarily storing loose items when traveling from one place to another. Storage problems can arise not only in small personal vehicles, such as the family automobile, but also in regard to larger vehicles, such as trucks, heavy equipment, and alternatively, in regard to smaller vehicles, such as motorcycles. In the absence of space provided by a dedicated storage compartment, it would be desirable to have a method of temporarily increasing storage space on the outside, or inside walls of the vehicle.

While increasing storage capacity can be accomplished in a variety of ways, vehicle owners generally do not wish to use permanent attachments, such as hooks, screws, or other hardware, as these may damage the walls or surfaces of the vehicle in question. It would be desirable to have a temporary storage device that can be attached to a surface of a vehicle without doing any permanent damage.

In the case of larger storage areas, such as the flatbed of a pickup truck, the problem is not so much adding additional temporary storage areas, but rather, enclosing and securing the large open storage area in the rear of the pickup truck. It would be desirable to be able to temporarily enclose a large storage area, such as the rear flatbed of a pickup truck, without damaging the surface of the vehicle.

Further, the type of securing device that is needed will vary based on the type of cargo. For example, a landscaper's pickup truck that is hauling lightweight leaves and clippings won't require a securing device as strong as a carpenter's pickup truck hauling wood. It would be desirable to have a method varying the type of securing device to suit the cargo being transported as well as the manner in which the securing device is attached to a vehicle.

Marine vehicles such as conventional boats, as well as smaller marine vehicles such as kayaks or Sea-Doos, place a high premium on storage space. For example, while transporting and storing equipment raises problems for land vehicles, storage problems related to transporting equipment with marine vehicles is worse due to the limited space available on most marine vehicles. It is very inconvenient to store and transport water-related equipment, such as surfboards, paddles, skis, life vests, goggles, scuba gear, and so forth, on boats, kayaks, and other types of water vessels because there may not be a way to secure the particular item in question. It would be desirable to have a temporary storage device that can be used in conjunction with marine vehicles without causing any permanent damage to the vehicle structure.

The foregoing discussion of marine vehicles illustrates another problem related to transporting items having a variety of shapes. In particular, when transporting items first via a land vehicle, then via a marine vehicle, and finally back to the land vehicle after the use of the marine vehicle is finished, the items being transported need to be secured properly in both vehicles. It would be desirable to have a single temporary storage device that can be used on either vehicle.

While the prior art has provided a variety of basic storage solutions, they typically focus on permanent storage space in the vehicle such as glove compartments on automobiles. The prior art has failed to provide a single portable temporary storage device that can easily be moved from one category of vehicle to another without creating any structural damage to either vehicle, and further failed to provide a device having the means to vary the securing device based on the type of cargo and means to vary the strength of the connection between the securing device and the vehicle such that the device can provide secure storage of cargo having a range of size, weight and mass.

### SUMMARY OF THE INVENTION

The invention provides a suction-cup cargo netting device that can be secured to any type of vehicle, land-based or marine, or any other suitable surface such that items are secured by the device while they are being transported or while they are being stored at a selected location. The suction-cup cargo netting device uses a flexible net that has a plurality of flexible suction-cups on its periphery that secure to any smooth surface quickly and conveniently. After use, the suction-cups can be easily disengaged so that the suction-cup cargo netting device can be easily stored, or moved to another vehicle. The suction-cups are attached to the periphery of a central net that covers the items while they are being transported. The device provides the option of having interchangeable flexible netting to suit different size cargo as well as different weight cargo. Further, the device provides the option of varying the number of suction-cups to provide sufficient connection strength when heavier cargo types are transported.

### BRIEF DESCRIPTION OF THE DRAWINGS

FIG. 1 is a top plan view of a preferred embodiment of the suction-cup cargo netting system.

FIG. 2 is a perspective view of a preferred embodiment of the suction-cup cargo netting system secured to the open cargo section of a pickup truck.

FIG. 3 is partial view of a preferred embodiment of the suction-cup cargo netting system secured to a flat surface with items being held between the surface and the suction-cup cargo netting system.

### DETAILED DESCRIPTION OF THE PREFERRED EMBODIMENT

Prior to a discussion of the figures, an overview of the invention will be presented. The invention is a flexible net that can be temporarily secured to any suitable surface for the purpose of securing a variety of items quickly and conveniently. The invention uses flexible suction-cups arranged around the periphery of the flexible net that allow the flexible net to be removably secured to a surface without doing any permanent damage to that surface.

The device is designed for use primarily with vehicles due to the premium for space on both land and/or marine vehicles. However, those skilled in the art will recognize that the storage device provided by this invention is not limited to use solely by vehicles. It can be used anywhere that items need to be temporarily stored while avoiding any permanent damage to the surface of temporary storage location. The netting can resemble a cargo net made of bungee material with suction-cups attached on the outer edges. However, any suitable material, such as elastic, rubber, bungee cord, etc., can be used to fabricate the netting. The suction-cups can be conventional rubberized or and flexible suction-cups that are commercially available and used for a variety of applications. The advantage of using flexible suction-cups is that the net can be easily secured to any smooth surface. Further, the size of the net, and the number of suction-cups can vary depending on the intended items that it will secure. For example, a face mask and a pair of flippers for a snorkeler would require a much smaller net than that used to secure a surfboard to a boat, or to enclose the top of a pickup truck bed.

In addition to its uses on vehicles, the invention can also be used at fixed locations, such as a house or a business. For example, it can be used on a wall in the home, in bedrooms, in children's playrooms, in garages, etc. Likewise, it can also be used in the business establishment to hold items conveniently for short periods of time.

Another important advantage of this invention is that the configuration can be changed to suit more than one application. For example, during normal use for a particular application, a predetermined number of suction-cups may be used. However, the event that the type of item being stored is changed, the invention provides for additional suction-cups that may be attached or detached from the cargo net to allow for changes in the nature of the cargo or other circumstances. For example, if the suction-cup cargo netting system used on a pickup truck, the driver may want to add additional suction-cups if the driver intends to drive the pickup truck on a highway at a higher rate of speed. Those skilled in the art will recognize that the suction-cups can be attached to the flexible netting in any suitable manner. For example, they can clamp to the flexible netting, they can have a slot in their central posts that will secure the flexible net, etc.

Having discussed the invention in general, we turn now to a detailed discussion of the drawings.

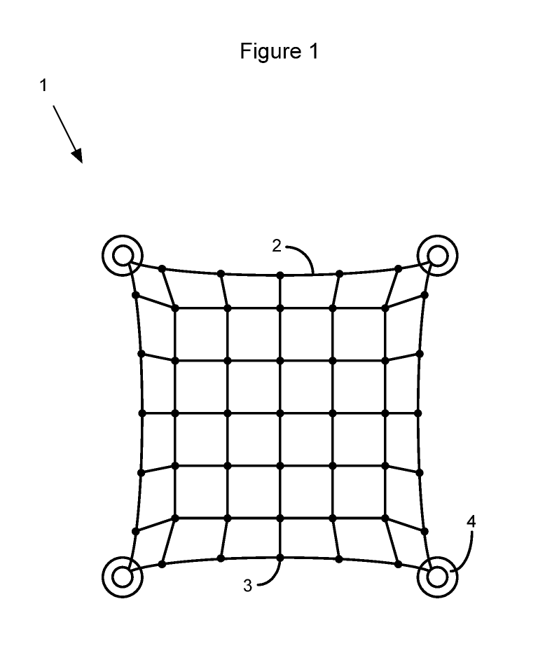

Regarding FIG. 1, this figure is a top plan view of a preferred embodiment of the suction-cup cargo netting system 1. As shown in this figure, a flexible net 2 is shown secured by a plurality of suction-cups 4. The suction-cups 4 are secured to the flexible net 2 at predetermined locations around the periphery of the flexible net 2. The configuration illustrated in this figure is for discussion purposes only. Those skilled in the art will recognize that the size of the flexible net 2 will vary depending on the types of items it is intended to secure. Of course, the number of suction-cups 4 will also vary depending on the size of the net, and/or the weight of the item it is intended to secure. Also illustrated in this figure are in knots or securing points that hold the webbing of the flexible net 2 in place. The knots can be actual knots that are tied at predetermined points, or just points that are secured via chemical bonding, adhesives, RF bonding, etc. The optimum method of creating a knot will be determined by the type of material used to fabricate the flexible net 2. While non-stretchable material can be used to fabricate the flexible net 2, a preferred embodiment of envisions a flexible material that will snuggly conform to the shape of the items being secured such that it will be restricted from moving.

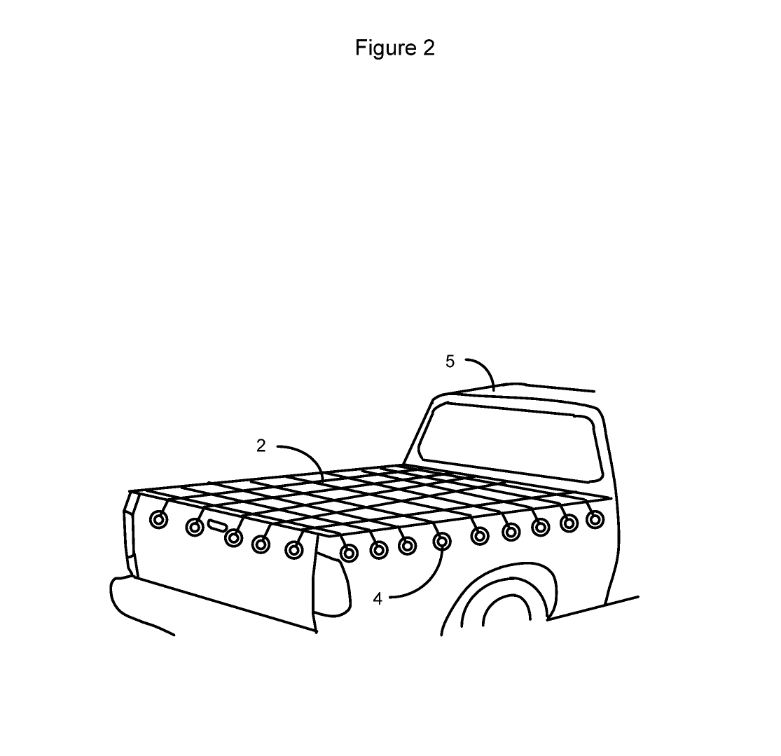

FIG. 2 is a partial perspective view of a preferred embodiment of the suction-cup cargo netting system 1 that is secured to the open cargo section of a pickup truck 5. Due to the large size a typical bed in a pickup truck 5, the suction-cup cargo netting system 1 is illustrated as a much larger device than that shown in FIG. 1. As can be seen, multiple suction-cups 4 are used. In this illustration, the entire top of the bed of the pickup truck 5 is enclosed by the suction-cup cargo netting system 1. This allows a pickup truck 5 carrying many items to securely transport them without worrying that they are going to fall out of the pickup truck 5 during transport.

As is the case in all of the embodiments, the suction-cup cargo netting system 1 can have a variable number of suction-cups 4. This allows the user to dynamically change the number of suction-cups 4 to provide a more secure storage area depending on the particular application at hand. As noted above, any suitable method of attaching the suction-cups 4 to the flexible net 2 can be used.

In addition, those skilled in the art will recognize that the mesh configuration used by the flexible net 2 can vary in density. For example, a landscaper carrying a truck filled with clippings would want to find mesh that would prevent any of the clippings from blowing out of a pick up truck 5 when it leaves a worksite. Therefore, the density of the weave used by the net 2 will also vary based on the intended use or the type of cargo. For example, a denser weave would be required to secure landscaper clippings than the weave required to secure lumber.

Another advantage illustrated by this figure is that the suction-cups 4 provide a secure attachment during use, but do not do any damage whatsoever to the paint on the surface of the pickup truck 5. Likewise, since the suction-cup cargo netting system 1 is detachable, it can be easily removed when not needed.

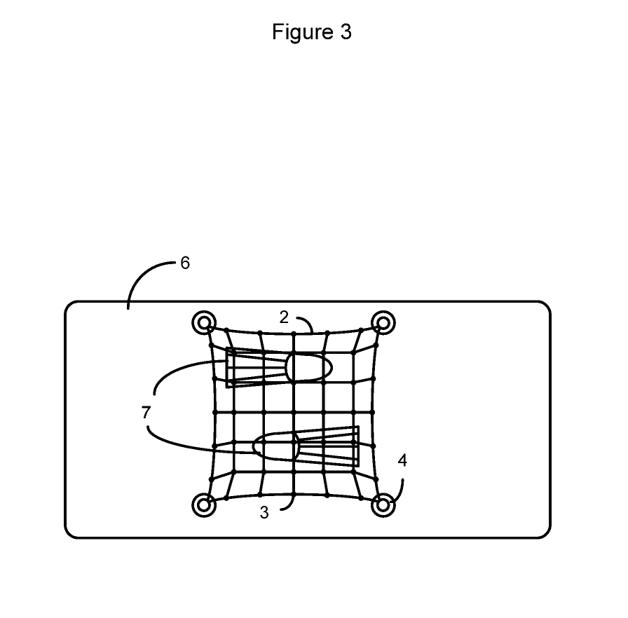

FIG. 3 is partial view of a preferred embodiment of the suction-cup cargo netting system 1 secured to a flat surface 6 with items 7 (in this case, a pair of swimming flippers) being held between the surface and the suction-cup cargo netting system 1. As noted above, the flat surface 6 can be any surface suitable for a suction-cup 4 to adhere to. It can be a surface on a land vehicle, on a marine vehicle, or on any smooth surface such as a wall in a building. In this example, the flexible net 2 holds the swimming flippers 7 in a secure and substantially immobile position. And because the suction-cup cargo netting system 1 is removable, it can be taken down when not needed and placed in storage.

For ease of discussion and illustration, the figures have shown the suction-cup cargo netting system 1 as either a square or rectangular device. However, those skilled in the art will recognize that the shape of the outer perimeter can be any suitable shape, such as a square, a rectangle, a circle, triangle, a semicircle, an irregular shape, etc. The only requirement is that the suction-cup cargo netting system 1 must be suitable for storing the particular item it was intended to store.

While specific embodiments have been discussed to illustrate the invention, it will be understood by those skilled in the art that variations in the embodiments can be made without departing from the spirit of the invention. The invention is a portable, removable, reusable, cargo netting system that provides additional storage space in a variety of locations and for a variety of applications. It can be used in land vehicles, marine vehicles, indoor or outdoor walls, or on any surface that is available for storage, and for which the user desires to avoid any damage to the surface. The suction-cups 4 can be manufactured from any suitable material that serves the purpose of the invention. Likewise, the flexible net 2 can also be fabricated from any material that will serve its purposes. Therefore, the invention shall be limited solely to the scope of the claims.

I claim:

1. A suction-cup cargo netting system, comprising:
a cargo net;
a plurality of suction-cups, the suction-cup secured to a predetermined location on the cargo net; and
the plurality of suction-cups disposed such that when secured to an external surface, the cargo net is held in place adjacent the external surface such that a storage area is created between a cargo net and the external surface;
whereby the cargo net is secured through an external surface such that a temporary storage area is created.

2. A system, as in claim 1, wherein:
the cargo net is fabricated from a flexible material.

3. A system, as in claim 2, wherein:
the cargo net is fabricated from stretchable material;
whereby the stretchable material in the cargo net conforms to the shape of items being stored by it.

4. A system, as in claim 3, wherein:
the cargo net is fabricated from bungee material.

5. A system, as in claim 3, wherein:
the cargo net is fabricated from elastic material.

6. A system, as in claim 2, wherein:
the suction-cups are detachably attached to the cargo net;
whereby the number of suction-cups can be dynamically changed to accommodate different storage needs.

7. A system, as in claim 6, wherein:
the cargo net is fabricated from a flexible material.

8. A system, as in claim 7, wherein:
the cargo net is fabricated from stretchable material;
whereby the stretchable material in the cargo net conforms to the shape of items being stored by it.

9. A system, as in claim 8, wherein:
the cargo net is fabricated from bungee material.

10. A system, as in claim 9, wherein:
the cargo net is fabricated from elastic material.
